(19) United States
(12) Patent Application Publication
(10) Pub. No.: US 2025/0024838 A1
(43) Pub. Date: Jan. 23, 2025

(54) WOOD TREATMENT COMPOSITION, METHODS OF USE, AND TREATED WOOD

(71) Applicant: VIANCE LLC, Charlotte, NC (US)

(72) Inventors: Kevin J. Archer, Charlotte, NC (US); Kevin M. Brown, Charlotte, NC (US)

(21) Appl. No.: 18/712,798

(22) PCT Filed: Nov. 22, 2022
(86) PCT No.: PCT/US2022/050732

§ 371 Date: May 23, 2024

Related U.S. Application Data
(60) Provisional application No. 63/282,794, filed on Nov. 24, 2021.

(51) Int. Cl. A01N 43/80; A01N 25/02; B27K 3/34

(52) U.S. Cl. CPC A01N 43/80; A01N 25/02; B27K 3/34

(57) ABSTRACT

The presently claimed and described technology provides wood preservative compositions comprising a preservative, a wax, and an organic solvent, methods for using such compositions to treat wood, and the treated wood.

### BACKGROUND

Untreated or unpreserved wood, and particularly untreated wood exposed to various weather and climate elements, is subject to degradation from various natural causes. During wood preservation, chemical preservatives are deposited or fixed in the wood to prevent microbial decay, insect attack and maintain structural integrity, effectively extending the lifetime of the wood.

While traditional wood treatment chemicals, including creosote, pentachlorophenol, and chromated copper arsenate, provide desirable preservation characteristics in treated wood, these chemicals are being phased out due to their negative environmental impact including volatile organic compound (VOC) emissions and potential toxicity to plants and animals.

Thus, there is an ongoing need in the art for wood preservative compositions that extend the life of treated wood while having a minimal or reduced environmental impact.

### BRIEF SUMMARY

In one aspect, the disclosure provides a creosote-and pentachlorophenol-free wood preservative composition comprising:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula:

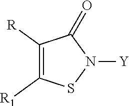

wherein,

Y is an unsubstituted or substituted (C₁-C₁₈) alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;

R and R₁ are independently hydrogen, halogen or (C₁-C₄)alkyl groups; or

R and R₁ can be taken together with the C═C double bond of the isothiazolone ring to form an unsubstituted or substituted benzene ring,
ii. a wax having a melting point between and inclusive of about 75° C. to 100° C.; and
iii. an organic solvent.

In some aspects of the composition, the preservative comprises 2-n-octyl-3-isothiazolone or 4,5-dichloro-2-n-octyl-3-isothiazolone.

In some aspects of the composition, the preservative comprises 4,5-dichloro-2-n-octyl-3-isothiazolone.

In some aspects of the composition, the wax is a petroleum wax, a synthetic wax, a natural wax, or a combination thereof.

In some aspects of the composition, the wax comprises a blend of a petroleum wax and a synthetic wax, wherein the petroleum wax comprises a microcrystalline wax and the synthetic wax comprises a Fischer Tropsch wax.

In some aspects of the composition, the melting point of the wax is between and inclusive of about 80° C. to 100° C.

In some aspects of the composition, the oil content of the wax is between and inclusive of about 1% to 10%.

In some aspects of the composition, the organic solvent is an aliphatic hydrocarbon, an alkyl C₁₄-C₂₄ methyl ester, a glycol ether, a petroleum distillate, diesel fuel, biodiesel fuel, a Diesel:Biodiesel blend, or a mixture or combination thereof.

In some aspects of the composition, the organic solvent is a Diesel:Biodiesel blend having a ratio of 50 to 70 parts by weight diesel fuel and 30 to 50 parts by weight biodiesel fuel. In some aspects of the composition, the composition comprises 0.5%-5% of at least one 3-isothiazolone compound based on total weight of the composition; 20%-60% of the wax based on total weight of the composition; and 35%-79.5% of the organic solvent based on total weight of the composition.

In another aspect, the disclosure provides a method for treating wood, the method comprising contacting the wood with a wood preservative composition comprising:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula:

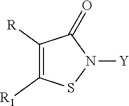

wherein,

Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;

R and R₁ are independently hydrogen, halogen or (C₁-C₄) alkyl groups; or

R and R₁ can be taken together with the C═C double bond of the isothiazolone ring to form an unsubstituted or substituted benzene ring,
ii. a wax having a melting point between and inclusive of about 75° C. to 100° C.; and
iii. an organic solvent,
   wherein the wood is treated at a temperature above the melting point of the wax.

In some aspects of the method, the preservative comprises 2-n-octyl-3-isothiazolone or 4,5-dichloro-2-n-octyl-3-isothiazolone.

In some aspects of the method, the preservative comprises 4,5-dichloro-2-n-octyl-3-isothiazolone.

In some aspects of the method, the wax has a melting point between and inclusive of about 80° C. to 100° C. and an oil content between and inclusive of about 1% to 10%.

In some aspects of the method, the organic solvent is an aliphatic hydrocarbon, an alkyl C₁₄-C₂₄ methyl ester, an ether, a petroleum distillate, diesel fuel, biodiesel fuel, a Diesel:Biodiesel blend, or a mixture or combination thereof.

In some aspects of the method, the organic solvent comprises a Diesel:Biodiesel blend having a ratio of 50 to 70 parts by weight diesel fuel and 30 to 50 parts by weight biodiesel fuel.

In some aspects of the method, contacting the wood with the wood preservative composition comprises pressure treating the wood with the wood preservative composition. In some aspects of the method, the pressure treatment is a vacuum-pressure treatment.

In some aspects of the method, the temperature of the vacuum-pressure treatment is about 85° C. to about 100° C.

In some aspects of the method, the wood is a railroad tie, bridge timber, a utility pole, a post, a piling, or a cross arm.

In a further aspect, the disclosure provides a treated wood, wherein the wood is impregnated with:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula:

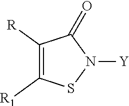

wherein,

Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;

R and R₁ are independently hydrogen, halogen or (C₁-C₄)alkyl groups; or

R and R₁ can be taken together with the C═C double bond of the isothiazolone ring to form an unsubstituted or substituted benzene ring;
ii. a wax having a melting point between and inclusive of about 75° C. to 100° C.; and
iii. an optional organic solvent.

In some aspects of the treated wood, the preservative comprises 2-n-octyl-3-isothiazolone or 4,5-dichloro-2-n-octyl-3-isothiazolone.

In some aspects of the treated wood, the preservative is 4,5-dichloro-2-n-octyl-3-isothiazolone.

In some aspects of the treated wood, the wax is a petroleum wax, a synthetic wax, a natural wax, or a combination thereof.

In some aspects of the treated wood, the wax comprises a blend of a petroleum wax and a synthetic wax, wherein the petroleum wax comprises a microcrystalline wax and the synthetic wax comprises a Fischer Tropsch wax.

In some aspects of the treated wood, the melting point of the wax is between and inclusive of about 80° C. to 100° C.

In some aspects of the treated wood, the oil content of the wax is between and inclusive of about 1% to 10%.

In some aspects of the treated wood, the organic solvent is an aliphatic hydrocarbon, an alkyl C₁₄-C₂₄ methyl ester, a glycol ether, a petroleum distillate, diesel fuel, biodiesel fuel, a Diesel:Biodiesel blend, or a mixture or combination thereof.

In some aspects of the treated wood, the wood is pine, Southern pine, radiata pine, ponderosa pine, lodgepole pine, Jack pine, hem-fir, Western larch, Douglas fir, birch, western red cedar, Alaskan Yellow cedar, white oak, red oak, hickory, or mixed hardwood.

In some aspects of the treated wood, the wood is a railroad tie, bridge timber, utility pole, post, piling or utility pole cross arm.

These and other advantages, aspects, and novel features of the present disclosure, as well as details of an illustrated embodiment thereof, will be more fully understood from the following description and drawings.

### BRIEF DESCRIPTION OF THE DRAWINGS

FIG. 1 is a representative image of the spray booth configuration of Example 7.

FIG. 2 illustrates results of swelling testing in treated wood samples of Example 8.

### DETAILED DESCRIPTION

Unless otherwise defined, all technical and scientific terms used herein have the same meaning as commonly understood by one of ordinary skill in the art to which the methods described herein belong. The singular form “a”, “an” and “the” include plural referents unless the context clearly dictates otherwise. These articles refer to one or to more than one (i.e., to at least one).

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise. Unless otherwise specified, all percentages are expressed in weight percent (%), based on the total weight of the composition or formulation.

The present disclosure relates to wood preservative compositions and methods for using such compositions to treat wood. The compositions and methods described herein can maintain the dimensional stability and surface integrity of wood and other wood materials, which can be degraded by extended exposure to ultraviolet light and water. Further, the compositions and methods can protect against and prevent, or at least reduce, wood deterioration, decay, and rot induced by microorganisms and insects such as termites, carpenter ants, and powderpost beetles.

As used herein, “wood”, “wood material”, and “wood substrate” refer to all forms of wood including solid wood (e.g., timber or lumber in the form of logs, beams, planks, sheets, and boards), wood composite materials (e.g., wood fiber board, chip board, and particle board), and products made from wood and wood composite materials (e.g., mill frames, decking, siding, siding cladding, roof shingles, railroad ties, and utility poles). Exemplary wood products that benefit from treatment with the compositions and methods disclosed herein include railroad ties, bridge timbers, utility poles, posts, piling, and cross arms.

“Dimensional stability” refers to the property of the wood materials and resultant treated wood materials related to resistance to swelling, warping or splitting of the wood product. “Surface integrity” refers to the property of the wood materials and resultant treated wood materials related to hardness and impenetrability, that is, resistance to deformation and softening of the wood surface.

In one aspect, the disclosure provides a creosote-and pentachlorophenol-free wood preservative composition comprising a preservative, a wax, and an organic solvent, wherein the preservative and wax are dissolved or dispersed in the organic solvent.

Preservatives of the present disclosure function as antimicrobial agents. As used herein, “antimicrobial”, “antimicrobial compound”, and “antimicrobial agent” refer to compounds that inhibit, or at least reduce, the growth of microorganisms including fungi (e.g., wood rotting basidiomycetes and mold) and bacteria. Preservatives can include bactericides, bacteristats, fungicides, fungistats, and termiticides. In some aspects, the preservative is a halogenated isothiazolinone or a halogenated carbamate fungicide.

In some aspects, the preservative of the composition is 2-n-octyl-4-isothiazolin-3-one (OIT), 3-iodo-2-propynyl-butylcarbamate (IPBC), triazoles (e.g., Tebuconazole, Propiconazole), 5-fluoro-1,3-dimethyl-N-[2-(4-methylpentan-2-yl)phenyl]pyrazole-4-carboxamide (i.e., penflufen), chlorothalonil, copper naphthenate, or oligomeric alkylphenol polysulfide (i.e., PXTS).

In some aspects, the preservative of the composition is a 3-isothiazolone having the Formula I:

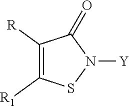

wherein:

Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;

R and R₁ are independently hydrogen, halogen or (C₁-C₄)alkyl groups; or

R and R₁ can be taken together with the C═C double bond of the isothiazolone ring to form an unsubstituted or substituted benzene ring.

“Substituted alkyl group” as used herein refers to an alkyl group having one or more hydrogens replaced by another substituent group; examples include hydroxyalkyl, haloalkyl and alkylamino. “Substituted aralkyl group” means an aralkyl group having one or more hydrogens on either the aryl ring or the alkyl chain replaced by another substituent group; examples include halo, (C₁-C₄)alkyl, halo (C₁-C₄)alkoxy and (C₁-C₄)alkoxy. “Substituted aryl group’ refers to an aryl group, such as phenyl, naphthyl or pyridyl group, having one or more hydrogens on the aryl ring replaced by another substituent group; examples include halo, nitro, (C₁-C₄)alkyl, halo-(C₁-C₄)alkoxy and (C₁-C₄)alkoxy.

Suitable 3-isothiazolone compounds include, for example, 2-methyl-3-isothiazolone, 2-methyl-5-chloro-3-isothiazolone and other 2-(C₁-C₅)alkyl-3-isothiazolone derivatives. In some aspects, the 3-isothiazolone compound is a 3-isothiazolone of Formula I, where Y is an unsubstituted or substituted (C₆-C₁₈)alkyl group, or an unsubstituted or substituted (C₆-C₁₈)alkenyl or alkynyl group.

In some aspects, the 3-isothiazolone is selected from 2-n-octyl-3-isothiazolone or 4,5-dichloro-2-n-octyl-3-isothiazolone (DCOI). In exemplary aspects of the composition, the preservative is DCOI. In some aspects, the preservative is 0.5%-5% by weight of the composition. In some aspects, the preservative is 1%-10% by total weight of the composition, alternatively 1%-4% by total weight of the composition, alternatively 1.5%-3.5% by total weight of the composition, alternatively 2%-3% by total weight of the composition. In treated wood, the preservative is 0.05 pcf-0.5 pcf (0.8 kg/m³-8 kg/m³). In some aspects, in treated wood, the preservative is 0.1 pcf-0.4 pcf (0.16 kg/m³-6.4 kg/m³)

Waxes of the present disclosure include petroleum waxes, scale waxes, synthetic waxes, natural waxes (e.g., carnauba or montan), or a combination thereof. In some aspects, the wax is a petroleum wax, such as but not limited to microcrystalline wax. In some aspects, the wax is a synthetic wax, such as but not limited to, Fischer Tropsch wax, polyethylene wax, or oxidized polyethylene wax.

In some aspects, the wax composition is a blend of microcrystalline wax, Fischer Tropsch wax, polyethylene wax, and/or oxidized polyethylene wax. For example, in exemplary aspects, the wax composition is a blend of Fischer Tropsch wax and microcrystalline wax.

In some aspects, the wax is 20%-60% by total weight of the composition, alternatively 30%-50% by total weight of the composition, alternatively 30%-40% by total weight of the composition.

Exemplary waxes of the disclosure provide a good water repellency to wood and wood products, have a melting point between, and inclusive of, 75° C.-110° C., alternatively 75° C.-100° C., alternatively 80° C.-100° C., and an oil content between, and inclusive of, 0.1%-10%, alternatively 1%-10%. In some aspects, waxes of the disclosure have a melting point between, and inclusive of, 85° C.-95° C. In some aspects, waxes of the disclosure have an oil content of about 1%. The melting point of the wax is of particular importance. Waxes having high melting points prevent or minimize leaching/depletion of active preservatives due in in-use environmental conditions, specifically high temperature environments in which treated wood may be used.

To produce the compositions of the present disclosure, the preservative and wax are dissolved or dispersed in an organic solvent. Suitable solvents include, but are not limited to, aliphatic hydrocarbons, esters (e.g., alkyl C₁₄-C₂₄ methyl esters), ethers (e.g., glycol ethers), petroleum distillate, diesel fuel, biodiesel fuel, Diesel:Biodiesel blends and mixtures thereof. Exemplary solvents of the disclosure include Diesel:Biodiesel blends having a ratio of 70:30, 60:40, or 50:50. In some aspects, the organic solvent is a Diesel: Biodiesel blend having a ratio of 50 to 70 parts by weight diesel fuel and 30 to 50 parts by weight biodiesel fuel.

In some aspects, the preservative is 35%-80% by total weight of the composition, alternatively 40%-75% by total weight of the composition, alternatively 45%-70% by total weight of the composition. In exemplary aspects, the preservative is 35%-79.5% by total weight of the composition.

In some aspects, the composition can include one or more additional, optional ingredients. Such agents are known to one of ordinary skill and include emulsifiers, preservative solubility-enhancing agents, free radical initiators, nitrogen-containing compounds for improving distribution gradient, additional organic biocides, colorants, UV stabilizers, corrosion inhibitors, water repellents, antioxidants (e.g., pyrogallol and pyrogallate), and tertiary butyl hydroquinone (TBHTQ).

The collective ingredients of the composition result in lower preservative depletion in treated wood (i.e., reduced preservative leaching), reduced preservative migration out of the wood into the environment, improved climbability, enhanced efficacy, reduced tendency to produce surface residues, and an improved distribution gradient (i.e., penetration of the preservative into the wood) such that adequate preservative loading to prevent or reduce decay or termite attack is achieved.

In exemplary aspects, the composition of the present disclosure can be provided as a ready-to-use formulation. In some aspects, the composition or the ready-to-use formulation is a solid made up of a wax and an active ingredient (i.e., preservative). In some aspects, the composition or the ready-to-use formulation comprises a preservative and wax melted, dissolved or dispersed in an organic solvent such that the composition can be applied as a singular treatment. Alternatively, the composition of the present disclosure can be provided as one or more separate ingredients, such as the preservative and wax as a concentrate suitable for dilution in the solvent, or the preservative, wax, and solvent as individual ingredients suitable for combination to form the composition.

Advantages of the wood preservative compositions as disclosed herein include one or more of the following:
freedom from restricted-use pesticides (e.g., does not contain creosote or pentachlorophenol);
freedom from carcinogenic polycyclic aromatic hydrocarbons (PAH), dioxins, and furans;
low odor;
low volatile organic compound (VOC) emission as compared to creosote;
a high degree of wood penetration during treatment;
termite resistance in treated wood;
microbial-induced decay resistance in treated wood;
reduction of mechanical and/or environmental erosion in treated wood;
low migration of the composition from treated wood (i.e., reduced environmental impact/contamination and improved retention of active preservatives in treated wood);
reduction of electrical conductivity/impedance in treated wood;
reduction of leaching/depletion of active preservatives;
enhancement of dimensional stability and surface integrity in treated wood;
prevention or reduction of cracking and splitting of treated wood (prevents decay-causing exposure of untreated wood interior);
water repellency and reduced water uptake in treated wood; and
minimal or reduced dislodging of surface residue.

In another aspect, the disclosure provides methods of treating wood or wood materials with a composition as described herein. Generally, wood and wood materials can be treated with the compositions described herein by contacting the wood surface with the composition. Suitable contact methods for impregnation of a wood material with a composition as disclosed herein include pressure treating.

In some aspects, wood or wood material is treated using a pressure treatment, and more specifically, using vacuum-pressure treatment. Use of vacuum-pressure treatment can reduce treatment times and/or increase the penetration of the composition into the wood, making the preservative treatment more effective. In exemplary aspects, a wood or wood material is treated at about 80° C. to about 100° C. (or above the melting point of the wax in the composition) in a vacuum-pressure cylinder. It will be understood that the temperature, treatment duration, and vacuum-pressure parameters depend on the dimension, dryness, and type of wood being treated, as well as the composition of the treatment composition, and can readily be determined for a given treatment by those skilled in the art, in view of the teaching of the present disclosure.

Following treatment, the wood is removed from the cylinder such that the composition cools and the wax solidifies inside the wood cell. In some aspects, residual treatment solution can be removed via drip-drying or vacuum removal.

In some aspects, a method of treating wood or wood materials with a composition as described herein can include:
a. moving the charge of poles into a treatment cylinder, closing and sealing the door;
b. a conditioning: flood the cylinder with a hot treatment solution (85° C.), and re-circulate the solution while maintaining the temperature at 85° C. for 3 hours;
c. rueping: empty the cylinder of treatment solution (skip for Lowry);
d. rueping: increase the air pressure in the cylinder to 20 psi and hold for 20 minutes (skip for Lowry);
e. a rueping: flood the cylinder with a preservative solution while maintaining 20 psi in the cylinder (skip for Lowry);
f. increasing the pressure in cylinder to 150 psi, hold for 3 hours;
g. releasing the pressure and partially emptying the cylinder of treatment solution;
h. an expansion bath: pull a final vacuum of 15″ Hg, re-circulate the treatment solution for 1 hour while increasing the temperature to 92° C.;
i. emptying the cylinder, and pulling a final vacuum of >25″ Hg for 3 hours;
j. releasing the vacuum and emptying the cylinder of treatment solution;
k. opening the cylinder and removing the charge.

Wood to be treated with the compositions described herein can have a moisture content varying from dry to green, that is, moisture content from less than 20% by weight of the wood to 100% or more of the moisture composition of uncut wood. In exemplary aspects, the moisture content of wood to be treated is less than 20% by weight. However, it is not required that the wood is dried prior to treatment.

Woods suitable for treatment with the compositions and methods of the disclosure include, but are not limited to, pine, Southern pine, radiata pine, red pine, ponderosa pine, lodgepole pine, Jack pine, hem-fir, Western larch, Douglas fir, birch, western red cedar, Alaskan Yellow cedar, white oak, red oak, hickory, and mixed hardwoods.

In some aspects, green or partially seasoned material can be dried before treatment using the Boulton process. In the Boulton process, the wood is boiled in oil under vacuum. Green or partially seasoned stock is covered with a hot oil or an oilborne treating solution, a vacuum is applied, and the water is removed. Temperatures ranging from 82°-99° C. (180-210° F.) for 10-50 hours are used. Boulton-drying is used extensively for Douglas fir (Pseudotsuga menziesii) poles/piles treated with oilborne preservatives. Typically, 32-192 kg/m³ (2-12 pcf) of water are removed by the Boulton process. The process minimizes checking and improves treatability (Boulton, S. B. 1884. On the antiseptic treatment of timber. Minutes of the Proceedings of the Institution of Civil Engineers, 1883-1884 (London), vol. 78).

### EXAMPLES

### Example 1: Migration Studies of Treated Wood

To examine preservative migration under simulated gravity, treated wood samples were treated with a wax composition in 70:30 Diesel:Biodiesel, pentachlorophenol in 70:30 Diesel:Biodiesel, or creosote, and centrifuged in Falcon tubes for 0, 15, 30, or 60 minutes at 3200 rpm. At each interval, the weight of leached treatment composition (i.e., oil loss (g)) was measured. The wax composition (Treatment A) was a blend of a Fischer Tropsch synthetic wax and microcrystalline wax. Oil loss weight and oil loss percent are shown in Table 1.

These data demonstrate that under simulated gravity, wood migration of oil down an installed pole treated with the wax composition would be less than it would be from creosote or pentachlorophenol treated poles. Therefore, it would be expected that environmental contamination of the soil at the base of a wax composition-treated pole in service would be reduced.

TABLE 1
Oil Loss during Centrifugation

| Sample ID | | | Solution | Oil Loss (g) after min | | | | Oil Loss (%) after min | | | |
|---|---|---|---|---|---|---|---|---|---|---|---|
| Species | Group | Treatment | Conc. | 0 | 15 | 30 | 60 | 0 | 15 | 30 | 60 |

Wax Composition in 70:30 Diesel:Biodiesel (Treatment A)

| D-fir Sap | 1 | A | 2.0% | 0 | 0.003 | 0.010 | 0.031 | — | 0.063 | 0.226 | 0.670 |
|---|---|---|---|---|---|---|---|---|---|---|---|
| D-fir Sap | 2 | A | 2.0% | 0 | 0.004 | 0.013 | 0.031 | — | 0.091 | 0.311 | 0.728 |
| D-fir Sap | 3 | A | 2.0% | 0 | 0.007 | 0.016 | 0.028 | — | 0.156 | 0.353 | 0.615 |
| Wax Composition Average | | | | | | | | — | 0.103 | 0.297 | 0.671 |
| Birch | 2 | A | 2.0% | 0 | 0.236 | 0.275 | 0.316 | — | 4.029 | 4.688 | 5.386 |

Penta in 70:30 Diesel:Biodiesel (Treatment B)

| D-fir Sap | 1 | B | 6.0% | 0 | 0.059 | 0.123 | 0.212 | — | 1.281 | 2.670 | 4.582 |
|---|---|---|---|---|---|---|---|---|---|---|---|
| D-fir Sap | 2 | B | 6.0% | 0 | 0.028 | 0.069 | 0.149 | — | 0.618 | 1.498 | 3.243 |
| D-fir Sap | 3 | B | 6.0% | 0 | 0.056 | 0.107 | 0.207 | — | 1.153 | 2.176 | 4.229 |
| Penta Average | | | | | | | | — | 1.017 | 2.115 | 4.018 |
| Birch | 2 | B | 6.0% | 0 | 0.166 | 0.207 | 0.251 | — | 2.879 | 3.604 | 4.371 |

Creosote (Treatment C)

| D-fir Sap | 1 | C | 100% | 0 | 0.003 | 0.021 | 0.056 | — | 0.063 | 0.433 | 1.133 |
|---|---|---|---|---|---|---|---|---|---|---|---|
| D-fir Sap | 2 | C | 100% | 0 | 0.005 | 0.025 | 0.067 | — | 0.115 | 0.529 | 1.418 |
| D-fir Sap | 3 | C | 100% | 0 | 0.017 | 0.033 | 0.068 | — | 0.362 | 0.712 | 1.467 |
| Creosote Average | | | | | | | | — | 0.180 | 0.558 | 1.340 |
| Birch | 2 | C | 100% | 0 | 0.112 | 0.159 | 0.212 | — | 1.744 | 2.477 | 3.306 |

### Example 2: Water Uptake of Treated Wood

Repeating cycles of wetting and drying cause wood in service to shrink and swell, which results in cracking and splitting. This is especially true in standing, round wood poles and horizontally-orientated railroad crossties, bridge timbers, and utility cross-arms. Cracking and splitting of wood in service affects its structural integrity and engineering properties, and can expose the untreated zone deep in the wood to decay, fungi, and termites, thereby leading to premature failure. Treating wood with a formulation as disclosed herein can minimize the number of wetting and drying cycles that the wood is subjected to. The ability of the wax composition to reduce water uptake was investigated.

To investigate the effect of the wax compositions on water uptake, matched southern pine sapwood samples (15×29×100 mm) were treated with a wax composition+1.5% DCOI and a soluble polymer+1.5% DCOI in 5 different diluent oils. The wax composition was a blend of a Fischer Tropsch synthetic wax and a microcrystalline wax. After treatment, the samples were air dried for 1 week before testing. For the water uptake assessments, the samples were weighed and then fully immersed in water for 3 hours. After 3 hours, the samples were removed, blotted dry, and re-weighed. Water uptake was calculated from pre-and post-immersion weights. The samples were then dried, re-weighed, and immersed for 3 hours. Following the second immersion, the samples were weighed again to calculate water uptake. Results expressed as a percentage of the untreated control samples are shown in Table 2.

TABLE 2
Water Uptake of Treated Wood

| | | First 3 h immersion | Second 3 h immersion |
|---|---|---|---|
| | | Water Uptake | |
| | Oil | % of untreated | % of untreated |
| Treatment | type | control | control |
| Oil-only (No | 1 | 19 | 38 |
| DCOI) | 2 | 20 | 37 |
| | 3 | 32 | 62 |
| | 4 | 28 | 57 |
| | 5 | 19 | 42 |
| Wax composition + | 1 | 15 | 21 |
| DCOI | 2 | 15 | 18 |
| | 3 | 22 | 35 |
| | 4 | 18 | 29 |
| | 5 | 12 | 21 |
| Soluble polymer + | 4 | 20 | 51 |
| DCOI | | | |
| Untreated | — | 100 | 100 |

These data demonstrate the wax composition reduced the water uptake relative to oil-only or wood treated with DCOI and a soluble polymer.

### Example 3: Migration of DCOI from Treated Wood

The mobility of the wax composition (Fischer Tropsch synthetic wax and microcrystalline wax blend) relative to a non-wax soluble polymer composition was further evaluated using Alder. The non-wax soluble polymer composition was a polyurethane synthesized from a polyol, isocyanate, and a capping agent as described in WO 2020/068746, which is incorporated by reference herein in its entirety. Alder boards were cut to size 9×9×90 mm, and treated with different solutions containing DCOI. After treatment, the wood was air dried for 2 days prior to centrifugation. One set was heated to 55° C., while the remaining sets were tested at ambient temperature (20° C.). The treated test samples were placed in individual weighed centrifuge tubes, and subjected to a g-force approximating 100-x g in a benchtop centrifuge. The centrifugation process was repeated 3 times (with the centrifuge coming to a complete stop between each cycle). After the third centrifugation period, the wood sample was removed from the tube, and the tube re-weighed to determine the amount of solution that migrated out of the wood due to the simulated gravity. Migration of oil/preservative out of the wood is summarized in Table 3. These data demonstrate the wax combination signification reduced oil/preservative migration out of the wood relative to the soluble concentration.

TABLE 3
Oil/Preservative Migration from treated wood
under simulated gravity during Centrifugation

| | % Wax or | Oil Loss (%) @ temperature | |
|---|---|---|---|
| | Polymer | indicated | |
| Treating Solution | Additive | 20° C. | 55° C. |
| 2.5% DCOI in Oil Only | — | 5.4 | 6.5 |
| Treatment | | | |
| 2.5% DCOI + Wax | 1.5 | 0.3 | — |
| Composition | | | |
| 2.5% DCOI + Wax | 2.5 | 0.0 | 0.5 |
| Composition | | | |
| 2.5% DCOI + Soluble | 2.5 | 4.4 | — |
| polymer (non wax) | | | |
| Concentrate | | | |
| Creosote | — | 2.7 | 6.5 |

### Example 4: Leaching of DCOI from Treated Wood in Water

The leaching of DCOI from wood treated with the wax composition (Fischer Tropsch synthetic wax and microcrystalline wax blend) relative to wood treated with DCOI from a soluble concentrate was determined using the American Wood Protection Association (AWPA) E11 leaching procedure. Small blocks (19 mm cubes) were vacuum pressure-treated with the composition to achieve three different retentions of active ingredient. After conditioning, the treated blocks were leached in deionized water for a period of 14 days. Percentage loss of DCOI from the composition as well as leach rates are summarized in Table 4. Percentage loss data and leach rates for a different DCOI-containing composition without the wax are provided for comparison.

TABLE 4
Loss of DCOI from Treated Wood

| | Solution concentration | % Loss of | Leaching rate |
|---|---|---|---|
| Treatment | (% DCOI) | DCOI | (μg/cm²/day) |
| Soluble non wax | 0.678 | 10.2 | 1.90 |
| concentrate | 1.38 | 9.31 | 3.78 |
| | 2.8 | 9.03 | 7.37 |
| Wax composition | 0.926 | 1.95 | 0.58 |
| | 1.88 | 1.37 | 0.86 |
| | 3.70 | 1.11 | 1.42 |

The data summarized in Table 4 demonstrates the wax composition reduced leaching of active DCOI from treated wood immersed in water.

### Example 5: Leaching/Depletion of DCOI from Wood Placed in Soil Contact

To investigate the leaching/depletion of DCOI in combination with the wax composition (Fischer Tropsch synthetic wax and microcrystalline wax blend) from wood in soil contact, the American Wood Protection Association Standard E20 Standard Method for Determining the Leachability of Wood Preservatives in Soil Contact procedure was used.

Ten replicate test stakes (14 mm×14 mm×250 mm) were cut from each of five southern pine 1″×4″×8′ sapwood “parent” boards. A total of 50 stakes were produced. The test stakes were vacuum pressure-treated in a small laboratory pilot plant using a nominal 1.4% DCOI solution in combination with the wax composition in a 1:1 ratio, and then conditioned to 12% moisture content in a temperature humidity chamber. Once conditioned, the individual stakes were cut into two pieces. A first piece (150 mm in length) was prepared for exposure to soil and a second piece (100 mm in length) to be kept as a control for analysis. The pre- and post-treatment weights for each test stake were recorded to facilitate the calculation of preservative solution uptake.

Sections were then cut from each stake and set aside as control samples for analysis. In accordance with the E20 standard procedure, two types of soils were used for the study. A first soil was taken from a forested area in Harrisburg, NC and a second soil was taken from an open pasture located in Mooresville, NC. Soil from the top horizon to a maximum depth of 30″ was sampled from each location.

Ten plastic soil containers for each test soil were prepared. The two soils were sifted using a 10-mesh screen to remove large stones and debris. 10 mm of pea gravel was placed into each soil container, and then each container was filled with sifted soil. Once filled to the top, the soil was thoroughly wetted with de-ionized water, and left to sit for 24 hours to equilibrate. After 24 hours, excess water was drained. After draining, one pre-weighed treated stake from each of the five (5) parent boards was placed in each soil container. The cut ends of each stake were inserted into the soil in accordance with the E20 procedure.

The 10 soil containers were then covered with aluminum foil and weighed. The weight of each container. Each container was kept at that same weight for the duration of the 12-week experiment through the addition of de-ionized water, which was added as needed.

After 12 weeks of exposure, the stakes were removed from the soil, their surface cleaned, air-dried, and weighed. A 70 mm section was cut from the center of each exposed stake, and analyzed for DCOI content. A 20 mm section cut from the center of each corresponding unexposed (retained) control sample was also analyzed for DCOI content. The five replicate samples from each original board, and each soil sample were composited for analysis per AWPA Standard E20, and were extracted and analyzed for DCOI by HPLC.

As shown in Table 5, the loss of DCOI in two different soils over a 12-week period from southern pine treated with DCOI in combination with the wax composition ranged from 4.86% to approximately 13.75%. These values were significantly lower than the depletion from DCOI-treated material formulated with a non-wax composition.

TABLE 5
Loss of DCOI from Treated Wood in Soil Contact

| Treatment | Retention (pcf) | Soil type | % a.i. depleted |
|---|---|---|---|
| Wax Composition | 0.16 | Harrisburg | 4.86 |
| | | Mooresville | 13.75 |
| Soluble non wax | 0.20 | Harrisburg | 9.5 |
| composition | | Mooresville | 29.85 |

### Example 6: Dislodgeable Residues from the Surface of Treated Wood

A wipe sampling study was performed using the Modified California Roller Method to determine the amount of DCOI that dislodged from the surface of hardwood lumber (Sweet gum and Red oak) treated with a wood treatment composition of 50% DCOI and 50% wax and matching samples treated with DCOI in solvent alone. Dislodgeable Residue (DLR) testing was performed at a minimum 5 days after treatment. Wood samples from treated lumber were also taken to determine DCOI retention.

The DLR testing was performed using the Modified California Roller Method (a US EPA guideline method accepted by the EPA and other regulatory agencies). Suitable areas on available pressure-treated hardwood boards were randomly selected for surface residue sampling. A rectangular-shaped area designated by a 6″×5.5″ cloth wipe (TexWipe TX1009 polyester fabric) was used for sampling. Each wipe was moistened with 3 mL of 0.9% saline solution to double its original weight.

The wipes were damp but not dripping. The wipe test was conducted on the pressure-treated wood sample by placing the moistened fabric on the treated wood, covering the fabric with aluminum foil, and rolling a 12.5 kg roller pin back and forth over the foil ten times (i.e., 20 total passes). The wipe was removed from the wood, splinters the size of a grain of rice and larger removed, and the cloth placed in a labeled, coded, screw cap vial and analyzed for DCOI. Results are shown in Table 6. These data demonstrate the wax composition significantly reduced the DLR in both hardwood species.

TABLE 6
DLR Analysis of Treated Wood

| | Density | Treatment | | Retention (kg/m³) | | DLR (ng/cm²) | | |
|---|---|---|---|---|---|---|---|---|
| Species | kg/m³ | Type | Conc. | Solution | Actives | Average | Max | Min |
| Sweet Gum | 646 | DCOI | 1.5% | 101 | 1.52 | 339 | 564 | 172 |
| | 652 | Wax | 1.5% | 97 | 1.46 | 28.7 | 41.0 | 19.9 |
| | | Composition | | | | | | |
| Red Oak | 662 | DCOI | 1.5% | 131 | 1.96 | 149 | 2641 | 52.0 |
| | 663 | Wax | 1.5% | 113 | 1.69 | 55 | 468 | 20.3 |
| | | Composition | | | | | | |

### Example 6: Gaff and Pilodyn Penetration of Treated Wood

Gaff penetration is an important safety consideration for linemen climbing poles. The value of the wax composition (Fischer Tropsch synthetic wax and microcrystalline wax blend) for enhancing climbability in standing poles was evaluated using a gaff penetration test and a pilodyn pin penetration test. Waterborne chromated copper arsenate (CCA) treated wood was used as a control treatment. Southern pine pole material was used for the test. Matched samples were end- and side-sealed with epoxy resin before vacuum treatment with CCA in water and the wax composition in a 70 base oil. After treatment, matched samples were allowed to air dry and then conditioned to constant weight in a temperature-and humidity-controlled cabinet. Once conditioned, a quarter round section was tested in 4 separate areas to measure depth of penetration of a slide hammer gaff and a pilodyn pin. Results are summarized in Table 7.

TABLE 7
Gaff and Pilodyn Penetration of Treated Wood

| | | Sliding gaff | | Pilodyn | |
|---|---|---|---|---|---|
| | Retention | penetration | | penetration | |
| Treatment | (kg/m³ a.i.) | (mm) | % of CCA | (mm) | % of CCA |
| CCA (control) | 8.9 | 12.4 | 100 | 14.3 | 100 |
| Wax | 1.54 | 15.5 | 125 | 18.6 | 131 |
| composition | | | | | |

These data demonstrate the wax composition improves the penetration of the sliding gaff by 25% over the CCA control treatment. Similarly, the penetration of the pilodyn pin improved by 30% over the control treatment.

Example 7: DCOI Loss in Treated Douglas-fir Poles in a Simulated Rainwater Runoff Test

Preservative run-off from treated poles is a concern for treatment plant and utility storage yards. A laboratory-simulated shower test was performed to investigate preservative run-off from treated poles stored horizontally at treating plants and pole yards.

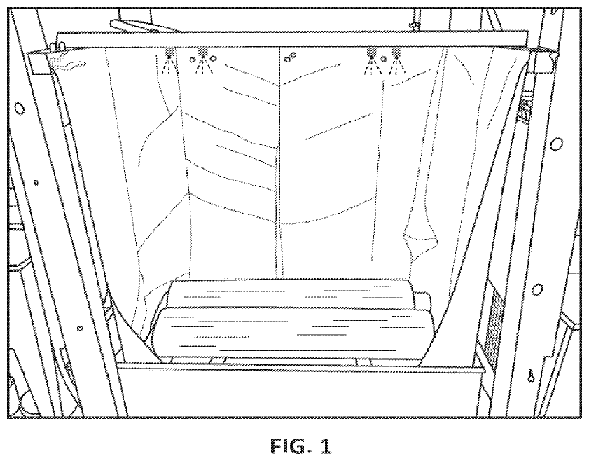

Two small Douglas fir post sections (0.21-0.23 m diameter×0.57 to 0.575 m long) were treated with DCOI in a 70:30 diesel/biodiesel diluent oil at 4.0% a.i. In addition, two Douglas fir post sections (0.21-0.24 m diameter×0.59 m long) were treated with DCOI and the wax blend composition in a 70:30 diesel/biodiesel blend at 4.0% a.i. The average DCOI assay of the treated wood without the wax composition was 0.63 pcf and the average assay in the DCOI+wax composition treated wood was 0.73 pcf. The two posts from each treatment were laid out horizontally in a simulated run-off chamber, with six spray nozzles arranged about 1 meter above the posts (FIG. 1). The total combined surface area for the DCOI only treatment exposed to the spray was 7915 cm² and the combined surface area of the DCOI+wax composition treated posts was 8433 cm². Each set of treated posts was subject to 4 hours of spray, which equated to approximately 3 cm of simulated rainfall. After completion of the 240-minute spray cycle, the posts were allowed to drip for about 10 minutes, and the total water collected in the pan under the posts drained, weighed, and then analyzed for DCOI content by HPLC.

For the HPLC analysis, the DCOI was extracted from the water using methanol, and concentrated through a C-18 cartridge. The results summarized in Table 8 demonstrate poles treated with the wax composition exhibited less DCOI loss as compared to poles treated with a non-wax composition.

TABLE 8
DCOI Loss from Treated Douglas-fir Poles

DCOI Loss

| Treatment | total (mg) | mg/m² |
|---|---|---|
| 4% DCOI without wax | 102.85 | 129.94 |
| 4% DCOI with the wax composition | 61.24 | 72.61 |

### Example 8: Swellometer Testing of Water Repellency

The AWPA E4 Standard Method of testing the efficacy of water repellent formulation was used to compare the anti-swelling properties of the wax composition relative to a DCOI in oil and a non-wax formulation containing DCOI. Wood wafers were impregnated with the water repellent preservative formulations and conditioned prior to immersion in water. The ability of the formulations to provide water repellency was established by measuring the tangential swelling of the treated and untreated wafers after submersion for 60 minutes.

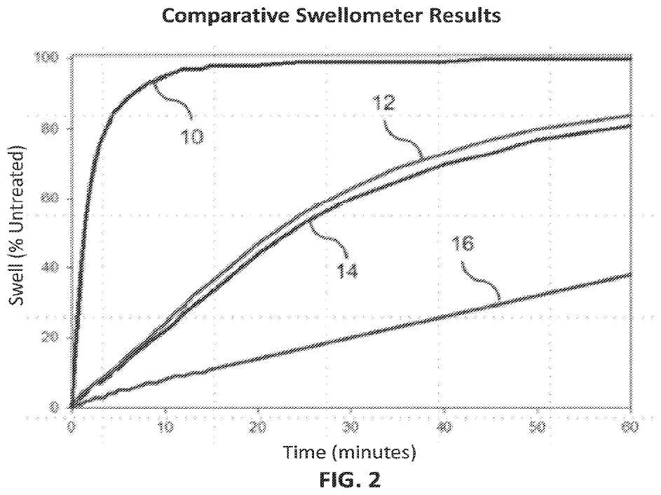

FIG. 2 illustrates results of swelling testing in treated wood samples of Example 8. In FIG. 2, plot 16 shows the result of treatment with DCOI+Wax Composition, plot 14 shows the result of treatment with the DCOI Non-wax Formulation, plot 12 shows the result of treatment with an oil solvent, and plot 10 shows the untreated, control result. The results shown in FIG. 2 demonstrate that the wax composition significantly reduced the swelling of the matched boards.

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

We claim:

1. A creosote-and pentachlorophenol-free wood preservative composition comprising:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula: 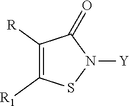
wherein,
Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;
R and R₁ are independently hydrogen, halogen or (C₁-C₄)alkyl groups; or
R and R₂ can be taken together with the C═C double bond of the isothiazolone ring to form an unsubstituted or substituted benzene ring,
ii. a wax having a melting point between and inclusive of about 75° C. to 100° C.; and
iii. an organic solvent.

2. The composition of claim 1, wherein the preservative comprises 2-n-octyl-3-isothiazolone or 4,5-dichloro-2-n-octyl-3-isothiazolone

3. The composition of claim 1 or claim 2, wherein the preservative comprises 4,5-dichloro-2-n-octyl-3-isothiazolone.

4. The composition of any one of claims 1-3, wherein the wax is a petroleum wax, a synthetic wax, a natural wax, or a combination thereof.

5. The composition of claim 4, wherein the wax comprises a blend of a petroleum wax and a synthetic wax, wherein the petroleum wax comprises a microcrystalline wax and the synthetic wax comprises a Fischer Tropsch wax.

6. The composition of claim 4 or 5, wherein the melting point of the wax is between and inclusive of about 80° C. to 100° C.

7. The composition of any one of claims 4-6, wherein the oil content of the wax is between and inclusive of about 1% to 10%.

8. The composition of any one of claims 1-7, wherein the organic solvent is an aliphatic hydrocarbon, an alkyl C₁₄-C₂₄ methyl ester, a glycol ether, a petroleum distillate, diesel fuel, biodiesel fuel, a Diesel:Biodiesel blend, or a mixture or combination thereof.

9. The composition of any one of claims 1-8, wherein the organic solvent comprises a Diesel: Biodiesel blend having a ratio of 50 to 70 parts by weight diesel fuel and 30 to 50 parts by weight biodiesel fuel.

10. The composition of any one of claims 1-9, wherein the composition comprises:
i. 0.5%-5% of at least one said 3-isothiazolone compound based on total weight of the composition;
ii. 20%-60% of the wax based on total weight of the composition; and
iii. 35%-79.5% of the organic solvent based on total weight of the composition.

11. A method for treating wood, the method comprising contacting the wood with a wood preservative composition comprising:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula: 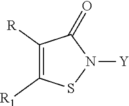
wherein,
Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;
R and R₁ are independently hydrogen, halogen or (C₁-C₄)alkyl groups; or
R and R₁ can be taken together with the C═C double bond of the isothiazolone ring to form an unsubstituted or substituted benzene ring,
ii. a wax having a melting point between and inclusive of about 75° C. to 100° C.; and
iii. an organic solvent,
wherein the wood is treated at a temperature above the melting point of the wax.

12. The method of claim 11, wherein the preservative comprises 2-n-octyl-3-isothiazolone or 4,5-dichloro-2-n-octyl-3-isothiazolone.

13. The method of claim 11 or claim 12, wherein the preservative comprises 4,5-dichloro-2-n-octyl-3-isothiazolone.

14. The method of any one of claims 11-13, wherein the wax has a melting point between and inclusive of about 80° C. to 100° C. and an oil content between and inclusive of about 1% to 10%.

15. The method of any one of claims 11-14, wherein the organic solvent is an aliphatic hydrocarbon, an alkyl C₁₄-C₂₄ methyl ester, an ether, a petroleum distillate, diesel fuel, biodiesel fuel, a Diesel:Biodiesel blend, or a mixture or combination thereof.

16. The method of any one of claims 11-15, wherein the organic solvent comprises a Diesel:Biodiesel blend having a ratio of 50 to 70 parts by weight diesel fuel and 30 to 50 parts by weight biodiesel fuel.

17. The method of any one of claims 11-16, wherein contacting the wood with the wood preservative composition comprises pressure treating the wood with the wood preservative composition.

18. The method of claim 17, wherein the pressure treatment is a vacuum-pressure treatment.

19. The method of claim 18, wherein the temperature of the vacuum-pressure treatment is about 85° C. to about 100° C.

20. The method of any one of claims 11-19, wherein the wood is a railroad tie, bridge timber, a utility pole, a post, a piling, or a cross arm.

21. A treated wood, wherein the wood is impregnated with:
i. a preservative selected from the group consisting of 3-iodo-2-propynyl-butylcarbamate, Tebuconazole, Propiconazole, 5-fluoro-1,3-dimethyl-N-[2-(4-methylpentan-2-yl)phenyl]pyrazole-4-carboxamide, chlorothalonil, copper naphthenate, oligomeric alkylphenol polysulfide, and a 3-isothiazolone compound having formula: 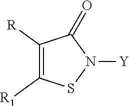
wherein,
Y is an unsubstituted or substituted (C₁-C₁₈)alkyl group, an unsubstituted or substituted (C₂-C₁₈)alkenyl or alkynyl group, an unsubstituted or substituted (C₆-C₁₂)cycloalkyl group, an unsubstituted or substituted (C₇-C₁₀)aralkyl group, or a substituted (C₇-C₁₀)aryl group;
R and R₁ are independently hydrogen, halogen or (C₁-C₄)alkyl groups; or
R and R₁ can be taken together with the C═C double bond of the isothiazolone ring to form an unsubstituted or substituted benzene ring;
ii. a wax having a melting point between and inclusive of about 75° C. to 100° C.; and
iii. an optional organic solvent.

22. The treated wood of claim 21, wherein the preservative comprises 2-n-octyl-3-isothiazolone or 4,5-dichloro-2-n-octyl-3-isothiazolone.

23. The treated wood of claim 21 or claim 22, wherein the preservative comprises 4,5-dichloro-2-n-octyl-3-isothiazolone.

24. The treated wood of any one of claims 21-23, wherein the wax is a petroleum wax, a synthetic wax, a natural wax, or a combination thereof.

25. The treated wood of claim 24, wherein the wax comprises a blend of a petroleum wax and a synthetic wax, wherein the petroleum wax comprises a microcrystalline wax and the synthetic wax comprises a Fischer Tropsch wax.

26. The treated wood of claim 24 or claim 25, wherein the melting point of the wax is between and inclusive of about 80° C. to 100° C. 27 The treated wood of any one of claims 24-25, wherein the oil content of the wax is between and inclusive of about 1% to 10%.

28. The treated wood of any one of claims 21-27, wherein the organic solvent is an aliphatic hydrocarbon, an alkyl C₁₄-C₂₄ methyl ester, a glycol ether, a petroleum distillate, diesel fuel, biodiesel fuel, a Diesel:Biodiesel blend, or a mixture or combination thereof.

29. The treated wood of any one of claims 21-28, wherein the wood is pine, Southern pine, radiata pine, red pine, ponderosa pine, lodgepole pine, Jack pine, hem-fir, Western larch, Douglas fir, birch, western red cedar, Alaskan Yellow cedar, white oak, red oak, hickory, or mixed hardwood.

30. The treated wood of any one of claims 21-29, wherein the wood is a railroad tie, bridge timber, utility pole, post, piling or utility pole cross arm.
